(19) United States
(12) Patent Application Publication
(10) Pub. No.: US 2001/0023486 A1
(43) Pub. Date: Sep. 20, 2001

(54) Security management system and security managing method

(76) Inventors: Makoto Kayashima, Yamato (JP); Masato Terada, Sagamihara (JP); Yasuhiko Nagai, Tokyo (JP); Hiromi Isokawa, Fujisawa (JP); Kazuo Matsunaga, Yokohama (JP); Eri Katoh, Yokohama (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/859,429

(22) Filed: May 18, 2001

Related U.S. Application Data
(62) Division of application No. 09/761,742, filed on May 18, 2001.

(30) Foreign Application Priority Data
Sep. 6, 2000 (JP) 2000-270186
Jan. 20, 2000 (JP) 2000-12123

(51) Int. Cl. H04L 9/00; H04L 9/32; G06F 11/30; G06F 12/14

(52) U.S. Cl. 713/200

(57) ABSTRACT

A security management and audit of a business information system in accordance with an information security policy is simplified. Provided is a security management and audit program database 133 in which the information security policy and an object system correspond to management and audit programs. The management and audit program corresponding to a range of the information security policy and the object system, which are designated by an operator, is retrieved and automatically executed. The management and audit program performs a management and audit concerning an information security policy of an object system corresponding to itself.

### BACKGROUND OF THE INVENTION

The present invention relates to a technology for supporting a control and management of a security state of an information processing system composed of various kinds of processing apparatuses connected to a network.

Recently, an information system using the Internet technology has been widely utilized as infrastructures for business activities, resulting in a more increase in importance of a security system for avoiding threats to information assets by illegal access to the information system and virus.

As a conventional technology for managing such a security system, the product called “Tivoli Security Management” produced by Tivoli Co. Ltd., has been known, which configures and changes the individual security systems on the information system, such as a firewall and anti-virus program.

### SUMMARY OF THE INVENTION

It has been desired to perform the security measures for the information system according to a series of procedures including preparation of information security policy that is a principle of measures based on a threat analysis for the entire information system, an introduction of the security system depending on the information security policy to the information system, and handling and management of the security system. As a recommendation of the security measure for the information system according to such procedures, there is the Security Evaluation Common Criteria (CC) internationally standardized as ISO15408 in June 1999.

However, according to the foregoing technology, there is no system for managing which security system is introduced to realize the security measure in accordance with the information security policy, and how the handling and management of the security system for each information security policy are carried out.

Therefore, the control and management of a security status of the information system in accordance with the information security policy have been difficult for a person other than managers possessing highly specialized knowledge pertaining to the information security policy and the security system. Further, burdens such as time and cost, required to control and manage the security status of the information system in accordance with the information security policy have been large.

The present invention has been made in view of the foregoing circumstances, and the present invention provides a technology including a system and software, which simplifies the control and management of security status of the information system in accordance with the information security policy.

Further, the present invention provides a technology including a system and software, which works as a support for making it possible to execute a series of procedures including preparation of the information security policy, an introduction of a security system to an information system in accordance with the information security policy, and handling and management of the security system, without highly specialized knowledge pertaining to the information security policy and the security system.

Furthermore, the present invention provides a construction service to the security system by the use of these technologies.

In a first aspect of the present invention, a plurality of management sections are prepared, which correspond to at least one managed system and at least one information security policy, and control security statuses of the corresponding managed systems so as to adjust the security statuses of the corresponding managed system to the corresponding information security policy. The management section corresponding to the information security policy and the managed system included in a range received from a user is extracted, and the management section is allowed to change the security status of the managed system corresponding to the management section so that the security status is adjusted to the information security policy corresponding to the management section.

Alternatively, a plurality of audit sections are prepared, which correspond to at least one managed system and at least one information security policy and audit the status of the security concerning the corresponding information security policy of the corresponding managed system. Then, an audit section corresponding to the information security policy and the managed system included in the range received from a user is extracted, and the audit section is allowed to audit the security status concerning the information security policy corresponding to the audit section of the managed system corresponding to the audit section.

In a second aspect of the present invention, first, there is prepared a database in which a correspondence of an information security policy representing a policy of a security measure to at least one managed system is described. Then, a designation of each managed system for constituting an information system constructed or to be constructed by a user is received, and information security policy registered so as to correspond to each managed system is extracted from the database, to hatch security specifications which specify, for example, a list illustrating correspondences of the managed systems constructing the information system to the information security policy and which are to be applied to the information system.

Then, a security management system introduced to the information system constructed by the user is allowed to execute a plurality of audit programs which describe processings for auditing various information such as a type and a software version of the managed system and a security status concerning the information security policy of the managed system, and which are made to correspond to a set of the information security policy and the managed system specified by the hatched security specifications. The various information such as the type and the software version of each managed system constituting the information system constructed by the user and the security status thereof are audited, and the security of the information system is diagnosed.

Then, of the plurality of management programs describing a processing for controlling the security status concerning the information security policy to which the managed system corresponds, and being made to correspond to the set of the information security policy and the managed system specified by the hatched security specifications, for example, the management program made to correspond to the set of the information security policy and the managed system, which are decided by the user that a change of security status thereof is needed based on a diagnose result of the security, is executed by a security management system introduced to the information system constructed by the user. The security status of the managed system corresponding to the management program is changed so that the security status thereof is adjusted to the information security policy corresponding to the management program.

### BRIEF DESCRIPTION OF THE DRAWINGS

FIG. 1 is a schematic constitutional view of an information system to which a first embodiment of the present invention is applied.

FIG. 2 is a schematic constitutional view of an information security policy management and audit support apparatus 31 shown in FIG. 1.

FIG. 3 is a schematic constitutional view of a management and audit object computer 32 shown in FIG. 1.

FIG. 4 is a drawing for explaining contents of a system constitution device information database 131 shown in FIG. 2.

FIG. 5 is a drawing for explaining contents of an information security policy database 132 shown in FIG. 2.

FIG. 6 is a drawing for explaining contents of a security management and audit program database shown in FIG. 2.

FIG. 7 is a flowchart showing operational procedures of an information security policy management and audit support apparatus 31 shown in FIG. 1.

FIG. 8 is a drawing showing a selection screen of an information security policy management and audit object area displayed in the step S701 of FIG. 7.

FIG. 9 is a drawing showing a selection screen of an information security policy displayed in the step S703 of FIG. 7.

FIG. 10 is a flowchart showing processing procedures in the step S705 of FIG. 7.

FIG. 11 is a drawing showing a change screen of an execution status of an information security policy/security measure displayed in the step S706 of FIG. 7.

FIG. 12 is a drawing showing an example of a display screen when a management program is started.

FIG. 13 is a flowchart showing an example of processing procedures when an audit program is started.

FIG. 14 is a drawing showing an audit result display screen of the information security policy.

FIG. 15 is a drawing showing an audit result display screen of the information security policy.

FIG. 16 is a drawing showing an audit result display screen of the information security policy.

FIG. 17 is a drawing showing an audit result display screen of the information security policy.

FIG. 18 is a schematic constitutional view of an information security policy management and audit support apparatus 31′ used in a second embodiment of the present invention.

FIG. 19 is a drawing for explaining contents of a constitution device information/security status database 135 of the management and audit object system shown in FIG. 18.

FIG. 20 is a drawing schematically illustrating support procedures of a security management of the information system, which can be realized by the use of the security policy management and audit support apparatus 31′ shown in FIG. 18.

FIG. 21 is a flowchart showing operation procedures of the security policy management and audit apparatus 31′ in a design phase shown in FIG. 20.

FIG. 22 is a drawing showing an example of security specs.

FIG. 23 is a flowchart showing operation procedures of the security policy management and audit apparatus 31′ in an installation phase shown in FIG. 20.

FIG. 24 is a drawing showing an example of a written audit result report.

FIG. 25 is a drawing showing an example of the written audit result report when a record concerning illegal access is displayed as an audit result 2403.

FIG. 26 is a flowchart showing operation procedures of the security policy management and audit apparatus 31′ in a management phase shown in FIG. 20.

### DETAILED DESCRIPTION OF THE PREFERRED EMBODIMENTS

Embodiments of the present invention will be described below.

A first embodiment of the present invention will be first described.

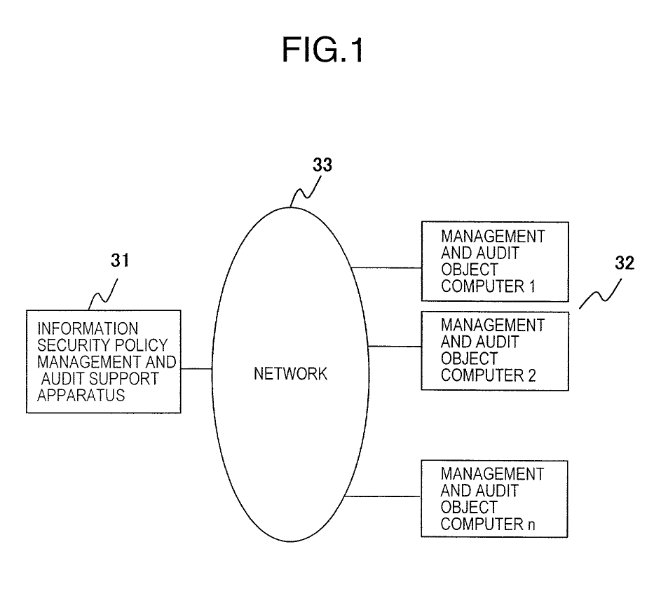

FIG. 1 is a constitutional view of an information system to which the first embodiment of the present invention is applied.

As shown in FIG. 1, the information system of this embodiment has a constitution in which an information security policy management and audit support apparatus 31 and management and audit object computers 32 such as a server, a router and a firewall are connected to each other through a net work 33.

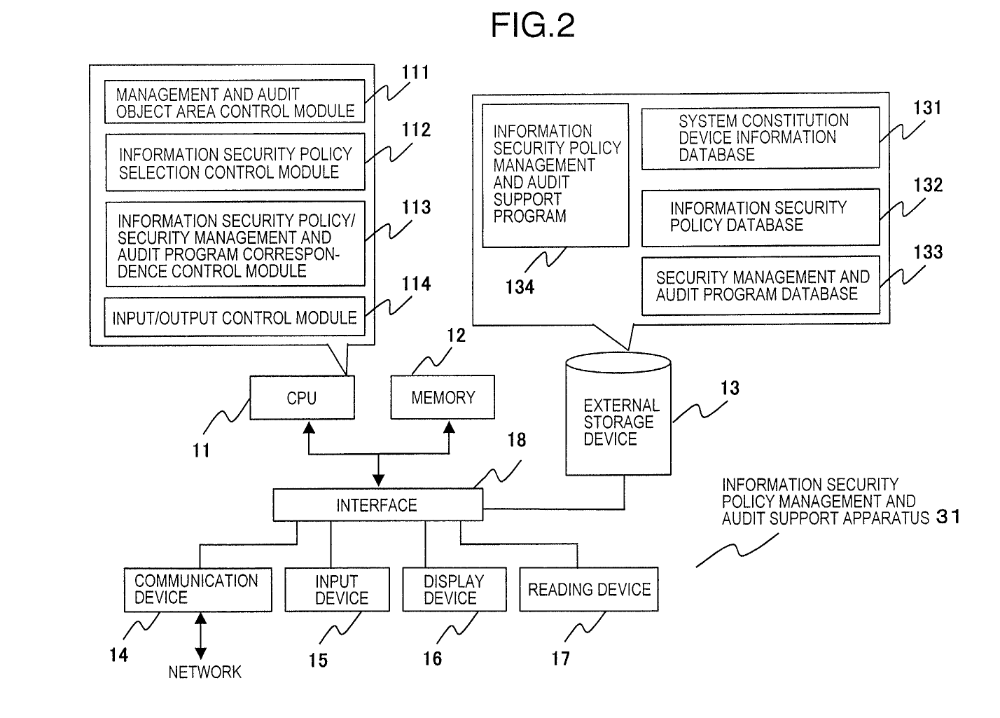

FIG. 2 shows a constitution of the information security policy management and audit support apparatus 31.

As shown in FIG. 2, a hardware structure of the information security policy management and audit support apparatus 31 can be constructed on a general electronic computer which comprises, for example, a CPU 11, a memory 12, an external storage device 13 such as a hard disc device, a communication device 14 connected to a network 33, an input device 15 such as a key board and a mouse, a display device 16 such as a display, a reading device 17 for reading out data from a storage medium having portability, such as an FD and a CD-ROM, and an interface 18 controlling data transmission/receiving among the foregoing constitutional components.

A support program 134 for constructing functions of the information security policy management and audit support apparatus 31 on the electric computer is stored in the external storage device 13. The CPU 11 loads the support program 134 onto the memory 12 and executes the support program 134, whereby the CPU 11 materializes a management and audit object area control module 111, an information security policy selection control module 112, an information security policy/security management and audit program correspondence control module 113 and an input/output control module 114 on the electronic computer. The CPU 11 also forms a system constitution device information database 131, an information security database 132 and a security management and audit program database 133 on the external storage device 13. Further, although not shown, a communication control module and the like for communicating with other devices through the network 33 are also constructed on the electronic computer.

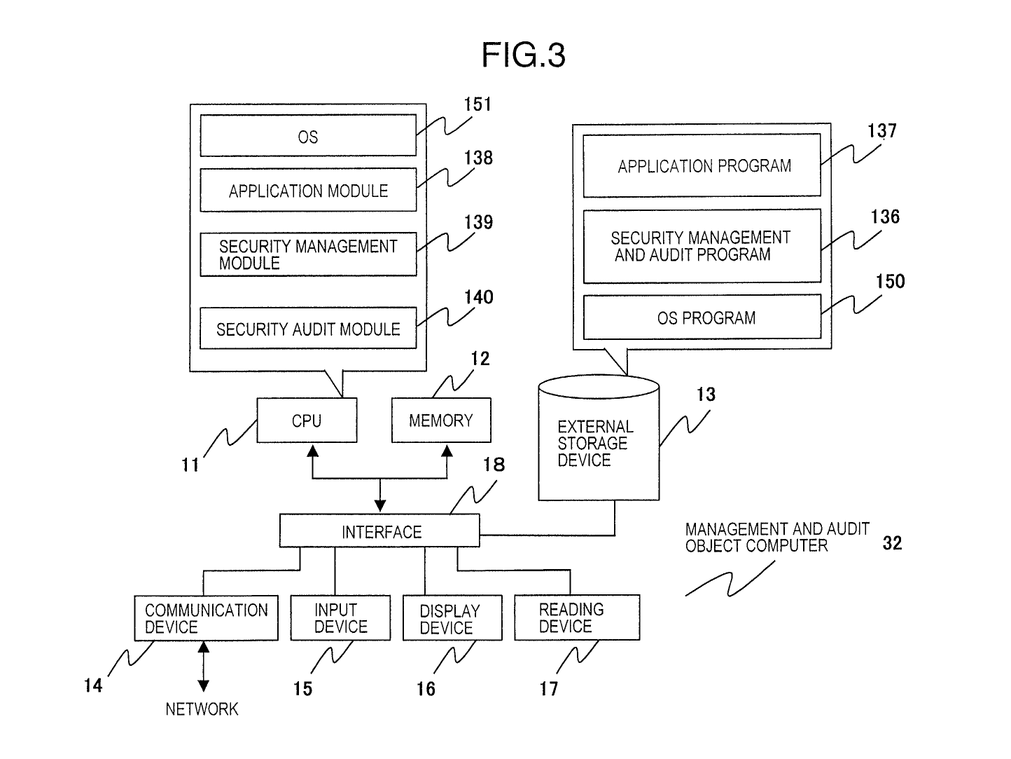

FIG. 3 shows a constitution of the management and audit object computer.

In FIG. 3, constitutional components having the same functions as those in the information security policy management and audit support apparatus 31 shown in FIG. 2 are denoted by the same reference numerals.

As shown in FIG. 3, an OS program 150 to operate on the management and audit object computer 32, an application program 137 and a security management and audit program group 136 for performing security management and audit for the application program 137 are stored in the external storage device 13 of the management and audit object computer 32.

The CPU 11 executes the OS program 150 loaded on the memory 12 to materialize an OS 151 on the electronic computer. Furthermore, the CPU 11 executes the application program 137 loaded on the memory 12, to materialize an application module 138 for offering each service of the server, the router and the firewall on the electronic computer. The CPU 11 executes a management program included in the security management and audit program group 136 loaded on the memory 12, to materialize a security management module 139 for establishing and changing a status of a security measure of the OS 151 and application module 138 on the electronic computer. The CPU 11 executes an audit program included in the security management and audit program group 136, to materialize a security audit module 140 for confirming the status of the security measure of the OS 151 and the application module 138 on the electronic computer. Moreover, although not shown, a communication control module and the like for communicating with other devices through the network 33 are also constructed on the electronic computer.

Databases of the information security policy management and audit support apparatus 31 will be described below.

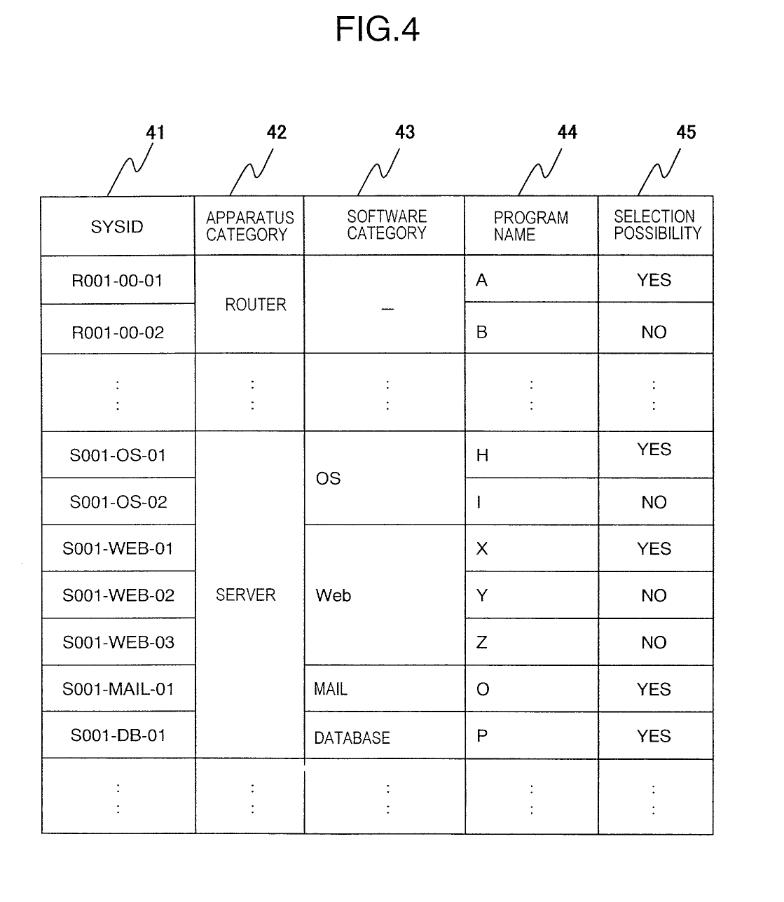

FIG. 4 shows contents of the system constitution device information database 131.

In FIG. 4, with respect to each line, column 41 describes an identifier SYSID for uniquely identifying a system that is an object of an information security policy management and audit. A column 44 describes a software name for constructing a system represented by the SYSID of the column 41. The software name includes names of the OS program 150 and application program 137. A column 42 describes categories of apparatuses in which the system represented by the SYSID of the column 41 operates. The apparatuses include the router, the server, the client, the firewall, and the like. And, a column 45 stores a selection result by an operator of the system represented by the SYSID of the column 41 is stored.

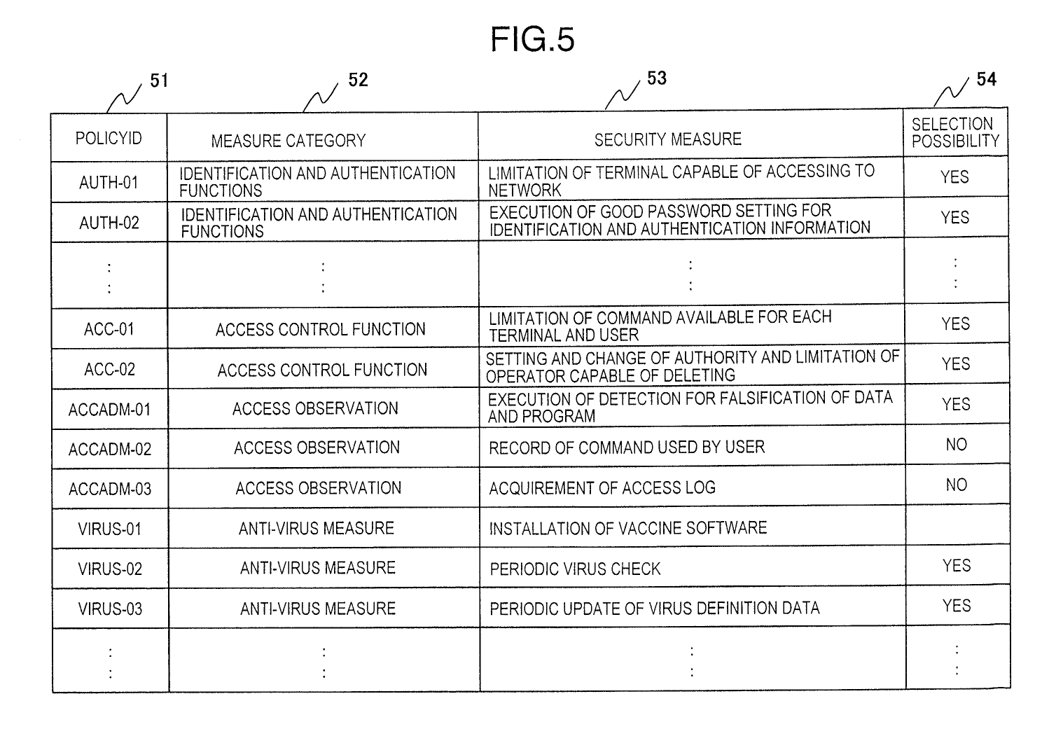

FIG. 5 shows contents of the information security policy database 132.

In FIG. 5, with respect to each line, column 51 describes an identifier POLICYID for uniquely identifying an information security policy. A column 52 describes measure categories of the information security policy described in the space of POLICYID of the column 51. The measure categories include, for example, an identification and authentication function, and an access control function. A column 53 describes a security measure expressing contents of the information security policy described in the space of POLICYID of the column 51. The security measure includes, for example, a limitation of a terminal capable of accessing to the network, and an execution of a good password establishment for identification and authentication information. Then, a column 54 stores a selection result by the operator of the information security policy represented by POLICYID of the column 51.

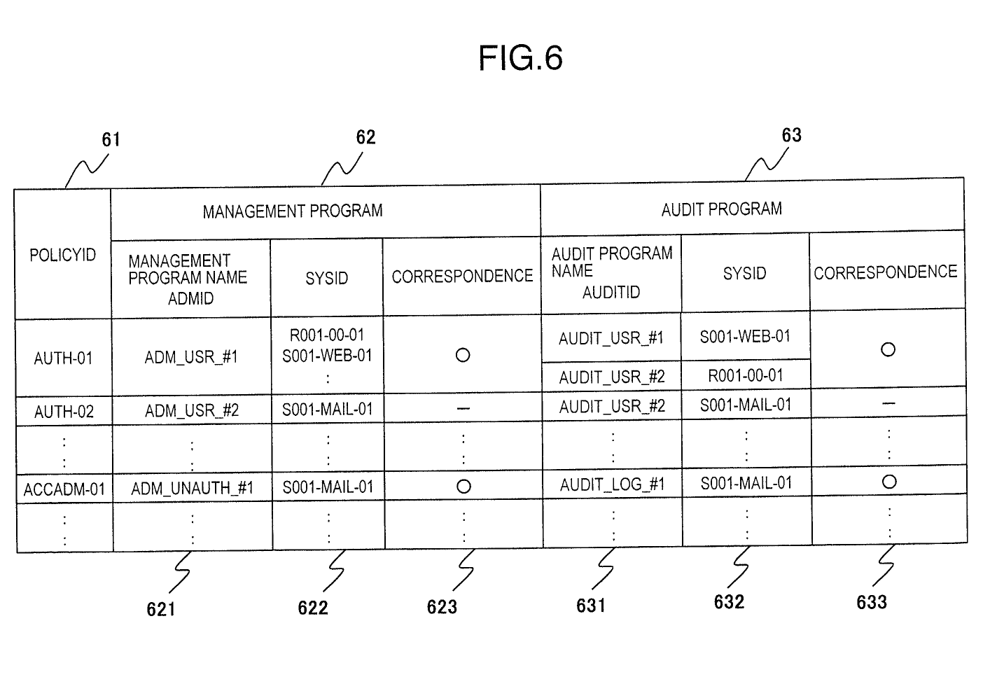

FIG. 6 shows contents of the security management and audit program database 133.

In FIG. 6, with respect to each line, a column 61 describes an identifier POLICYID for uniquely identifying the information security policy. The space of the management program of the column 62 describes a name 621 of the management program for performing a management of a security measure of the information security policy described in the space of the POLICYID of the column 61, SYSID 622 of the system managed by the management program of the name 621, and a correspondence 623 signifying the necessity of an execution of the management program of the name 621. The space of the audit program of the column 63 describes a name 631 of the audit program performing an audit for the security measure of the information security policy described in the space of POLICYID of the column 61, SYSID 632 of the system audited by the audit program of the name 631, and a correspondence 633 signifying the necessity of an execution of the audit program of the name 631.

An operation of the security policy management and audit in the above-described information system will be described below.

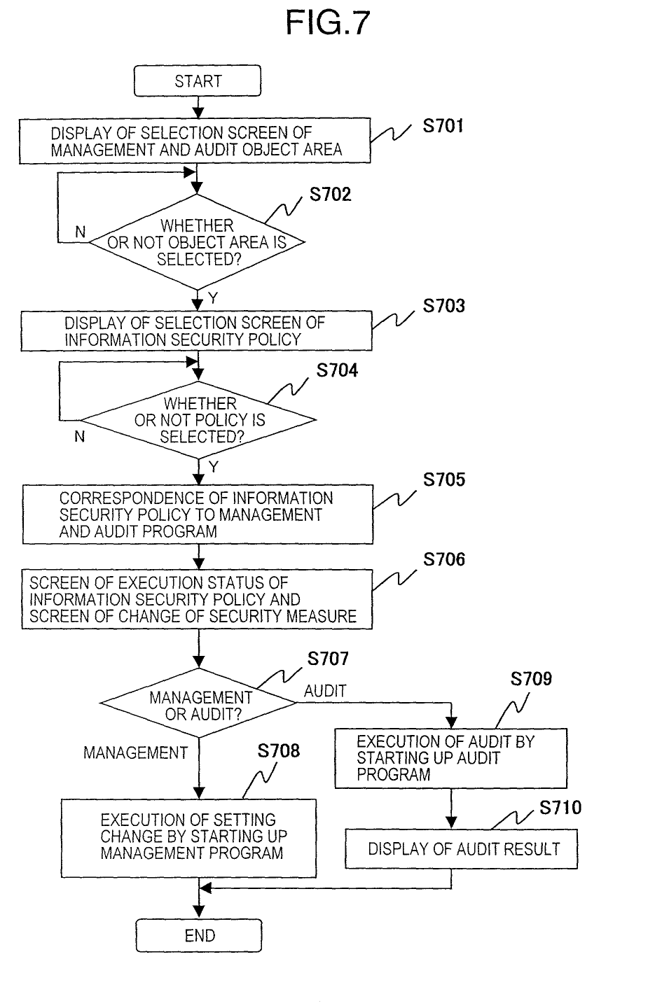

FIG. 7 shows operation procedures of the security policy management and audit apparatus 31.

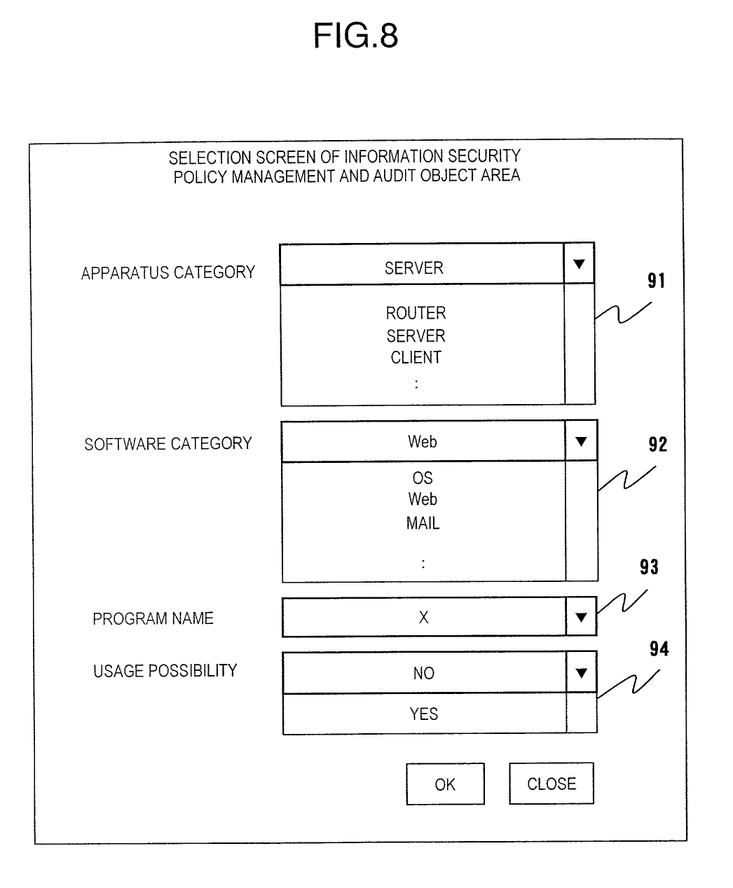

First, by the use of the input/output control module 114, the management and audit object area control module 111 allows the display device 16 to display a selection screen of an information security policy management and audit object area, as shown in FIG. 8, which represents contents registered in the system constitution device information database 131 formed on the external storage device 13 (step S701).

In FIG. 8, items, “Apparatus Category” 91, “Software Category” 92 and “Program name” 93, correspond to the columns 42, 43 and 44 of the system constitution device information database 131, respectively. On this screen, an operator designates the information security policy management and audit object area in optional items 91 to 93 and can select the same through the button of the item “Usage Possibility” 94. The selection result is reflected on the column 45 of the system constitution device information database 131 by the management and audit object area control module 111. That is, when a certain apparatus category is selected, “YES” is registered as a selection possibility in all of the lines of the column 45 corresponding to the lines of the column 42 describing this apparatus category. When a certain software category is selected, “YES” is registered as the selection possibility in all of the lines of the column 45 corresponding to the lines of the column 43 describing this software category. When a certain program name is selected, “YES” is registered as the selection possibility in all of the lines of the column 45 corresponding to the lines of the column 44 describing this software category.

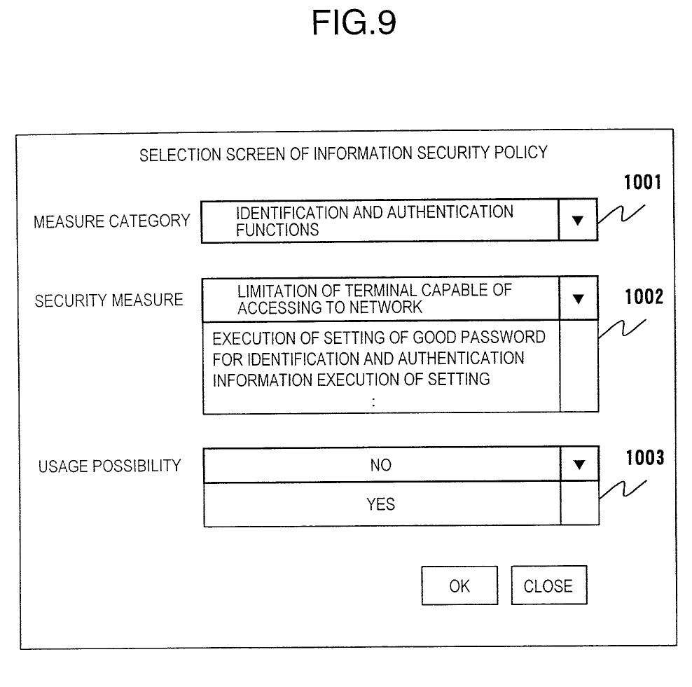

Then, when the information security policy management and audit object area is selected by the operator (step S702), the information security policy selection control module 112 uses the input/output control module 114 to allow the display device 16 to display the selection screen of the information security policy expressing the contents registered in the information security policy database 132 as shown in FIG. 9 (step S703).

In FIG. 9, items of “Measure Category” 1001 and “Security Measure” 1002 respectively correspond to the columns 52 and 53 of the information security policy database 132. On this screen, the operator designates the information security policy in optional items 1001 and 1002, and can select the information security policy by the button of the item “Usage Possibility” 1003. The selection result is reflected on the column 54 of the information security database 132 by the information security policy selection control module 112. Specifically, when a certain measure category is selected, “YES” is registered as the selection possibility in all of the lines of the column 54 corresponding to the lines of the column 52 describing the certain measure category. Further, when a certain security measure is selected, “YES” is registered as the selection possibility in all of the lines of the column 54 corresponding to the lines of the column 53 describing the security measure.

Then, when the information security policy is selected by the operator (step S704), the information security policy/security management and audit program correspondence control module 113 extracts management and audit programs corresponding to the selected security policy and the system from the security management and audit program database 133, on the basis of the selection result in the steps S701 to the steps S704. Then, the control module 113 registers the “Necessity” in the columns of correspondence 623 and 633 of the extracted management and audit programs (step S705).

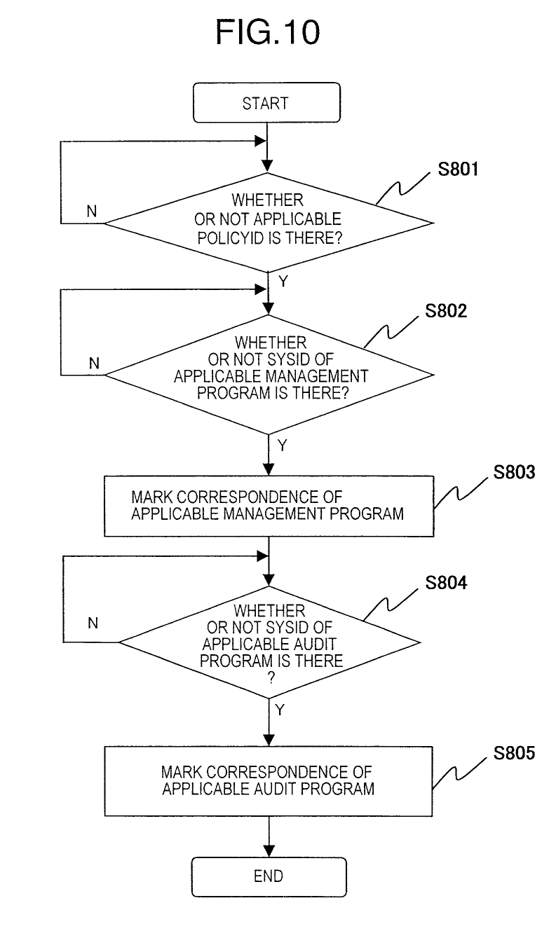

This extraction is carried out according to the procedures shown in FIG. 10.

That is, for the column 61, retrieval of the information security policy is carried out by the use of the existence of the identifier (POLICYID) selected in the step S704 (which means “YES” is registered in the column 54 in the information security policy database 132) in the security management and audit program database 133 (step S801). Then, for the column 622 situated in the same line as the retrieved identifier (POLICYID), extraction of the management program is carried out by the use of the existence of the identifier (SYSID) selected in the step S702 (which means “YES” is registered in the column 54 in the system constitution device information database 131) (steps S802 and S803). Then, for the column 632 situated in the same line as the retrieved identifier (POLICYID), extraction of the audit program is carried out by the use of the existence of the identifier (SYSID) selected in the step S704 (which means “YES” is registered in the column 54 in the system constitution device information database 131) (steps S804 and S805).

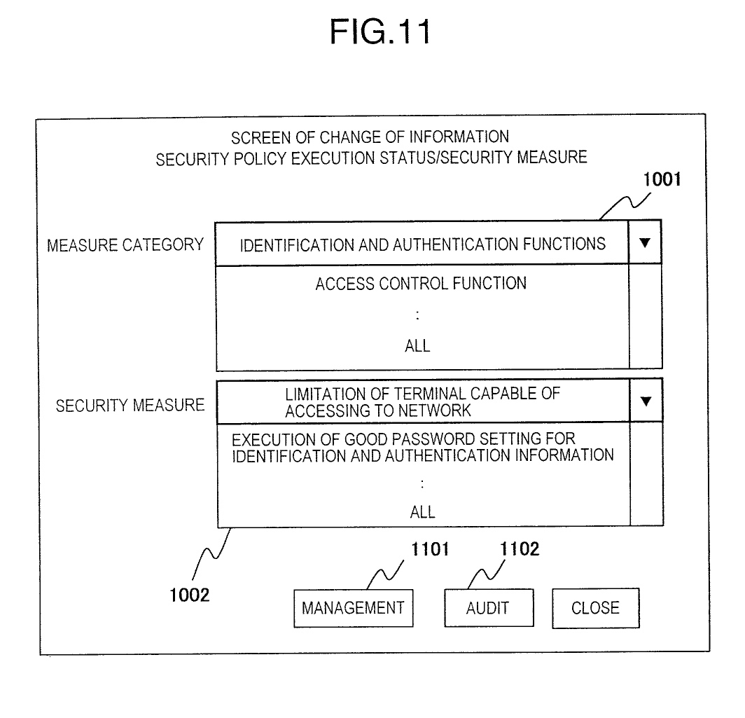

When the extraction of the management and audit programs is completed back in FIG. 7, the information security policy/security management and audit program correspondence control module 113 uses the input/output control module 114 to allow the display device 16 to display a screen for designating an execution status of the information security policy and a change of the security measure, as shown in FIG. 11 (step S706).

In FIG. 11, the items, “Measure Category” 1001 and “Security Measure” 1002, respectively correspond to the columns 52 and 53 of the information security policy database 132, and only the identifier selected in the step S704 (which means “YES” is set in the column 54) is displayed. In the items, “Measure Category” 1001 and “Security Measure” 1002, the operator can select one or more information security policies that are objects of the management and audit. Further, the item “Management” 1101 is a button for changing the security measure pertaining to the selected information security policy, by the use of the management program after the selection of the information security policy. The item “Audit” 1102 is a button for confirming the execution status of the information security policy pertaining to the selected information security policy by the use of the audit program after the selection of the information security policy. The operator can select any one of the buttons of “Management” 1101 and “Audit” 1102.

When the operator selects the information security policy and then he/she selects any one of the buttons of “Management” 1101 and “Audit” 1102 (step S707), the information security policy/security management and audit program correspondence control module 113 starts up any one of the security management program and the audit program extracted for the selected information security policy in the step S705 (which means the columns of correspondence 623 and 633 are marked by a symbol representing the “Necessity” of checking), through the network 33.

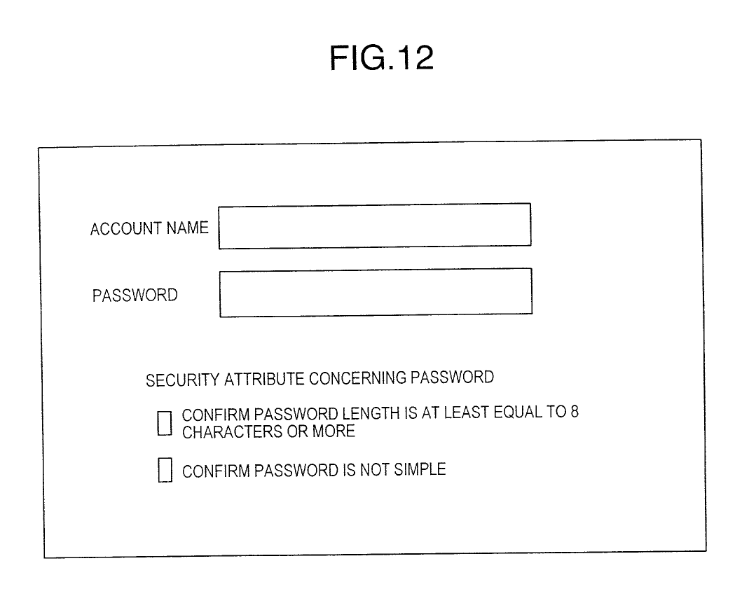

When the selected button is “Management” 1101, among the management and audit program group 136 on the management and audit object computer 32, a management program extracted in the above-described manner is started up and executed. The security management module 139, materialized by executing the management program, displays a management screen such as a setting change of the security system on the display device 16 of the management and audit object computer 32 as shown in FIG. 12 (step S708). Then, the security management module 139 receives the setting change of the security system and sets it therein. The security management module 139 responds to, and sends contents of the new setting of the security system, to the information security policy management and audit program correspondence control module 113 through the network 33. The information security policy/security management and audit program correspondence control module 113 that has received the response displays the contents of the new setting of the security system on the display device 16 of the information security policy management and audit support apparatus 31.

Note that FIG. 12 shows an example of a case where there is started up a password management program (management program name 621 “ADM_USR_{—}#2”) that is a management program for managing an information policy “AUTH-01” corresponding to the measure category 52 “Identification and Authentication Function” and the security measure 53 “Execution of Setting Good Password for Identification and Authentication Information” in the information security policy database 132 shown in FIG. 5. The screen of FIG. 12 is a screen for receiving a setting change of the password.

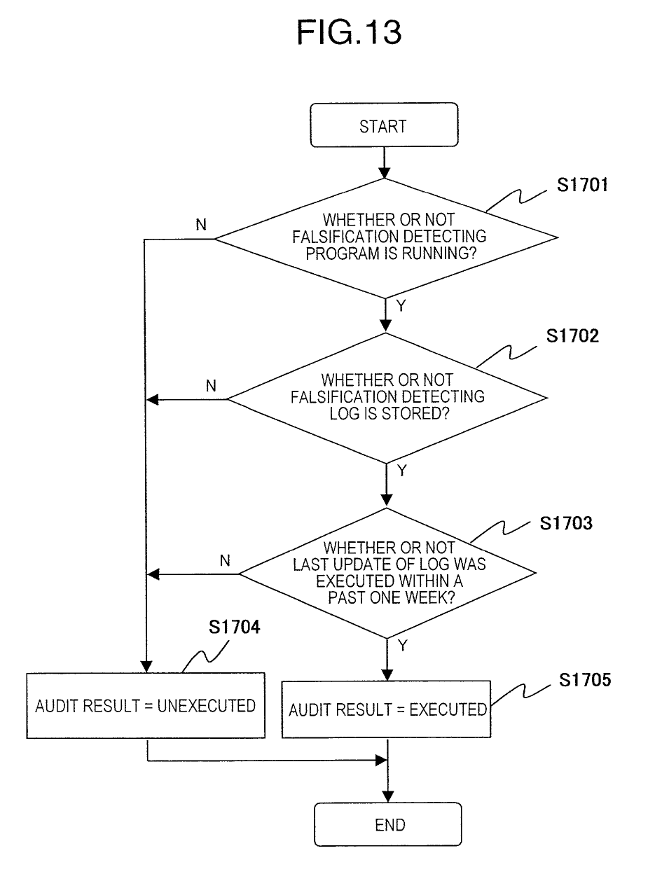

On the other hand, when the selected button represents “Audit” 1102 in the step S707, among the management and audit program group 136 on the management and audit object computer 32, the audit program extracted in the above-described manner is started up. Then, the security audit for the system audited by the audit program is performed, for example, by the operation procedures as shown in FIG. 13 (step S709). Then, the result of the security audit is sent to the information security policy/security management and audit program correspondence control module 113 through the network 33. The information security policy/security management and audit program correspondence control module 113 that has received the response displays the contents of the audit result on the display device 16 of the information security policy management and audit support apparatus 31.

Note that FIG. 13 shows an example of a case where a data falsification audit program (a management program name 621 “AUDIT_LOG_{—}#1 of FIG. 6) that is an audit program for managing an information security policy “ACCADM-01” corresponding to the measure category 52 “Access Audit” and the security measure 53 “Execution of Falsification Detection for Data Program” is started up in the information security policy database 132 shown in FIG. 5. In this example, the audit program confirms whether or not the falsification detection program itself is installed onto the management and audit object computer 32 and operated (step S1701), and then confirms whether an operation log thereof is stored (step S1702). Then, the audit program confirms an updated date of the operation log, whereby the audit program confirms a continuous operation of the falsification detection program (step S1703). Then, when the confirmations could be done for all of the items of confirmation, the audit program sends “Executed” to the information security policy/security management and audit program correspondence control module 113 as the audit result, since the audit result is good (step S1705). On the other hand, if this is not the case, the audit result is bad. Accordingly, the audit program responds to, and sends “Unexecuted” to, the information security policy/security management and audit program correspondence control module 113 as the audit result (step S1704).

When the information security policy/security management and audit program correspondence control module 113 receives the response concerning the audit result back in FIG. 7, the control module 113 displays the audit result on the display device 16 (step S710).

The first embodiment of the present invention has been described hereinabove.

This embodiment has described the case where the management and audit programs are provided for each program described in the column of the program name 44 in FIG. 4. However, the present invention shall not be limited thereto. For example, in the system constitution device information database 131 shown in FIG. 4, the management and audit programs are provided for each device described in the column 42 of the apparatus category and for each software described in the column 43 of the software category, and the management and audit programs may be executed in accordance with the selected apparatus category, the software category and the security measure.

When the management and audit programs are provided for each apparatus category, display of the audit results can be performed, for example, in the following manner.

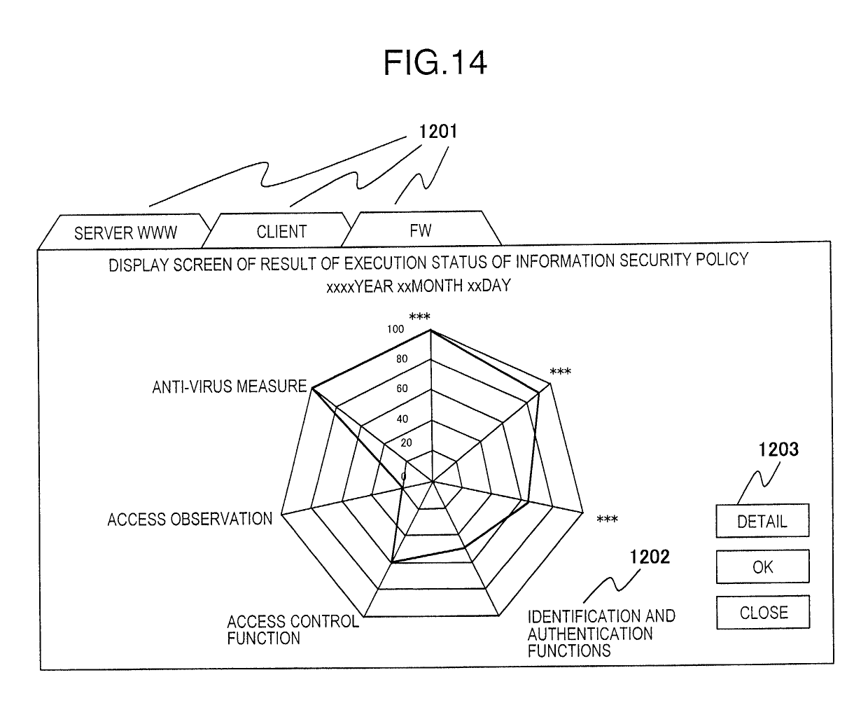

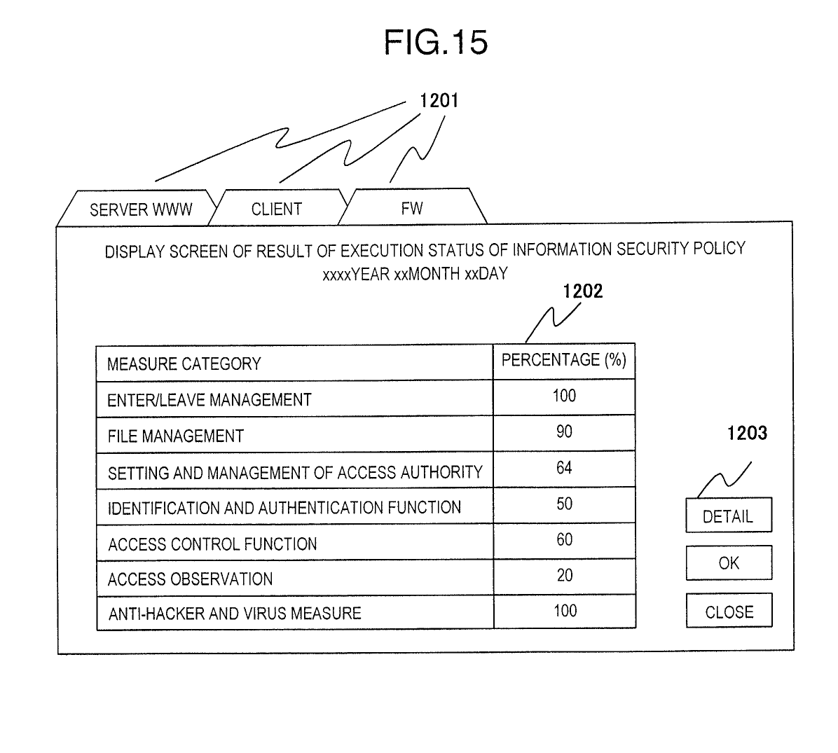

FIG. 14 shows an example in which, for each apparatus category 42 of the system constitution device information database 131 shown in FIG. 4, a proportion of the “Executed” to the total number of the security measures 53 of the measure category for the measure category 52 of the information security policy database shown in FIG. 5 is displayed by the use of a so-called radar chart. Further, FIG. 15 shows an example in which a proportion of the foregoing “Executed” is displayed by the use of a table.

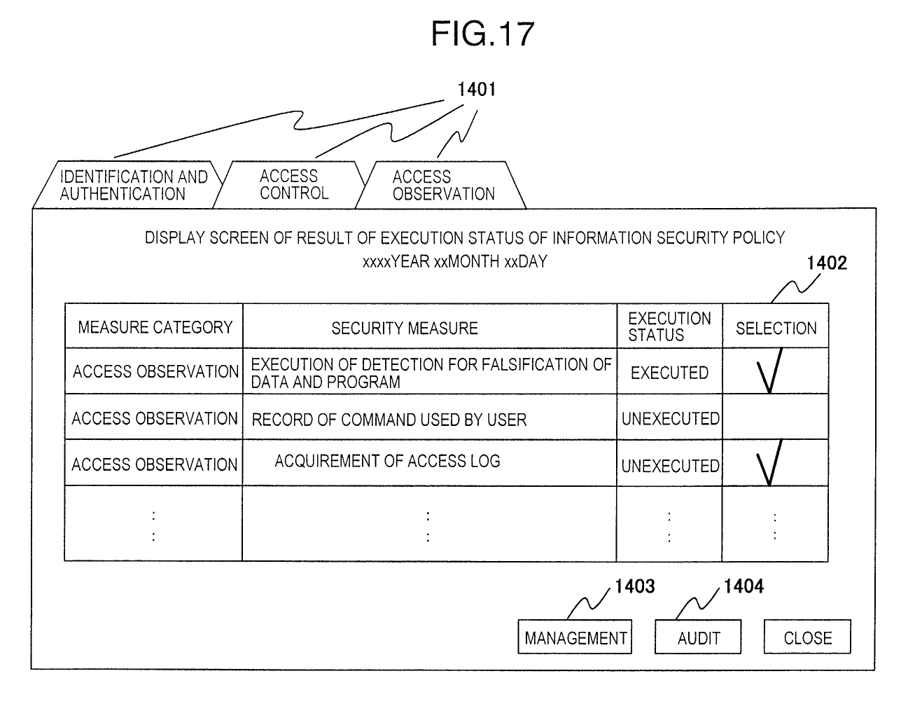

Either in FIG. 14 or in FIG. 15, the operator can display the audit result for each apparatus category 42 by designating a tag 1201. Moreover, when the operator designates the measure category 1202 and selects a button “Detail”, the audit results given by response for each security measure 53 are displayed, as shown in FIG. 17, for each measure category 52 of the information security policy database shown in FIG. 5.

In FIG. 17, when the operator wants to execute the management such as the setting change, or wants to execute the audit again, on the basis of the audit result, he/she checks the selection lines of the column 1402, and can select either the button “Management” 1402 for changing the security measure by the use of the management program or the button “Audit” 1403 for confirming the execution status of the information security policy by the use of the audit program.

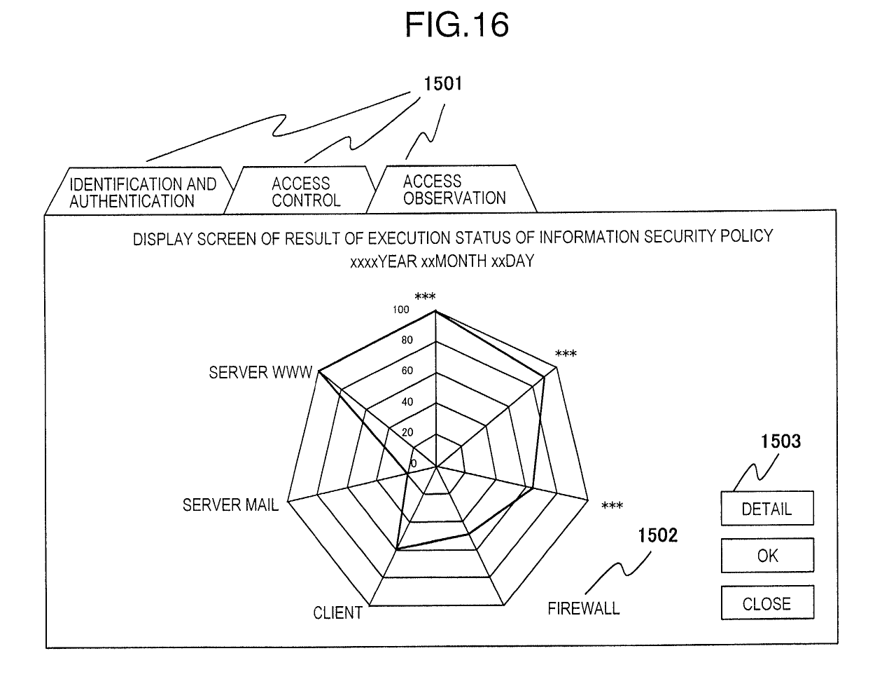

FIG. 16 shows an example in which, for each measure category 52 of the information security policy database shown in FIG. 5, a proportion of the “Executed” to the total number of the security measures 53 of the measure category for each apparatus category 42 of the system constitution device information database 131 shown in FIG. 4 is displayed by the use of a so-called radar chart.

In FIG. 16, the operator can display the audit result for each measure category 52 by designating the tag 1501. Further, when he/she designates an apparatus category 1502 and selects a button “Detail” 1503, the audit result given by response for each security measure 53 as shown in FIG. 17 is displayed for each measure category 52 of the information security policy database shown in FIG. 5.

According to this embodiment, the following effects are produced.

(1) The operator can select the security management and audit programs required for the constitution by only designating the system to be managed and audited and selecting the information security policy. It is therefore easy to attain the correspondence of the security system introduced to realize the security measure in accordance with the information security system.

(2) The management program for performing an application of the information security policy of the object system can be started up by only designating the management execution of the information security policy entered by the operator. In performing the handling and management of the information system in accordance with the information security policy, it is therefore easy even for a manager who has no highly specialized knowledge to perform the handling and management.

(3) It is possible to evaluate a status of the security measure based on the information security policy of the object system by only designating the audit execution for a status of the information security policy entered by the operator. In grasping the handling and management status of the information system in accordance with the information security policy, therefore, the execution is easy even for a manager who has no highly specialized knowledge.

A second embodiment of the present invention will be described hereinafter.

In this embodiment, the security policy management and audit support apparatus 31 described in the first embodiment is modified somewhat. Then, this embodiment describes a case in which, by the use of the modified apparatus 31′, the apparatus 31′ supports a manager so that he/she can execute a series of procedures including preparation of the information security policy to be applied to the user's information system, an introduction of the security system to the foregoing information system in accordance with the information security policy, and a handling and management of the security system.

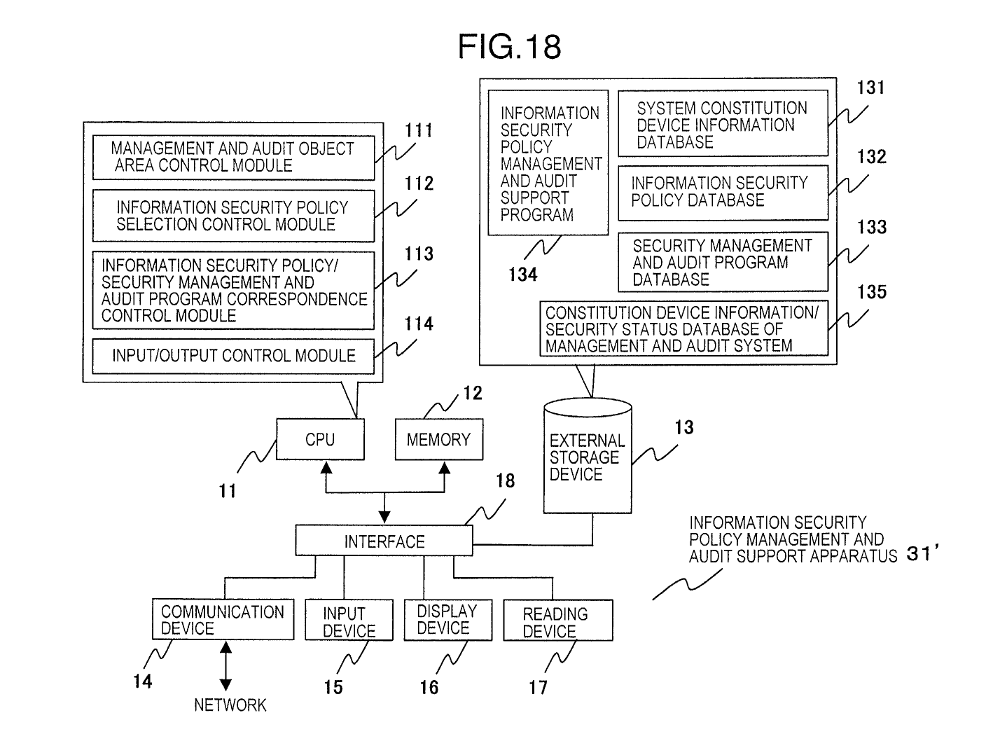

FIG. 18 shows a constitution of the security policy management and audit support apparatus 31′.

As shown in FIG. 18, the constitution of the security policy management and audit support apparatus 31′ used in this embodiment is principally identical to that of the first embodiment shown in FIG. 2. Note that the CPU 11 loads and executes on the memory 12 the support program 134 stored on the external storage device 13, whereby a constitution device information/security status database 135 of the management and audit object system is formed on the external storage device 13 in addition to the system constitution device information database 131, the information security database 132 and the security management and audit program database 133. This database 135 stores a status of the security measure for the system and various information including version information of the software program constructing the system, and a type of the apparatus in which the system operates, which are acquired from the management object system for the program by executing the corresponded audit program, in the database security management and audit program database 133 shown in FIG. 6.

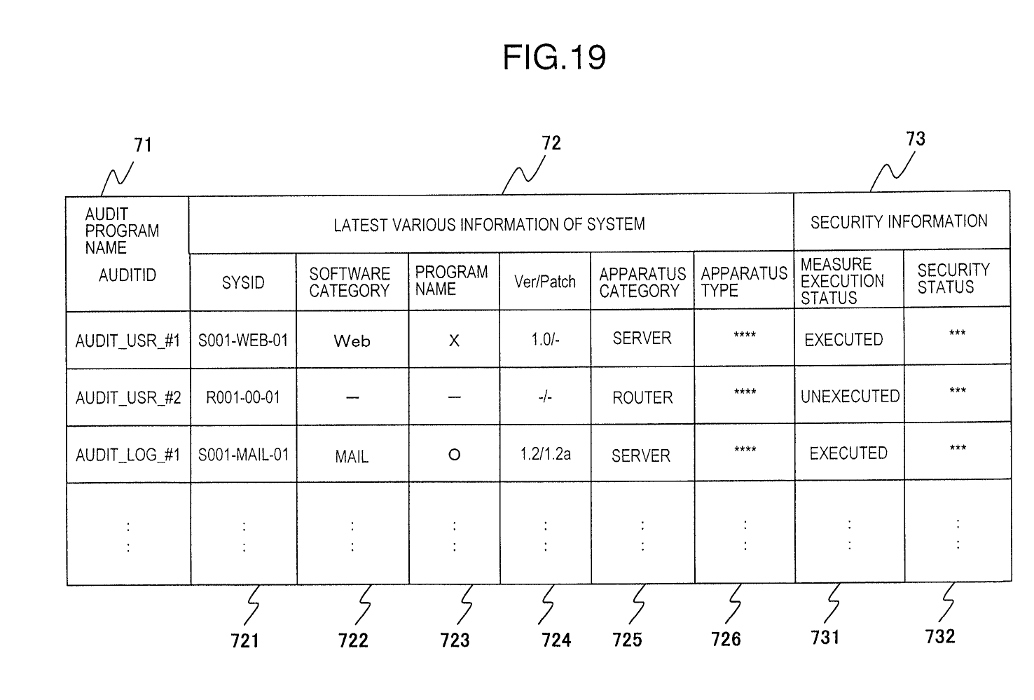

FIG. 19 shows contents of the constitution device information/security status database 135 of the management and audit object system.

In FIG. 19, with respect to each line, the name (AUDITID) of the audit program is described in the column 71. The column 72 describes the newest various information of the system to be audited by the audit program, the information including: SYSID 721 of the system to which the audit program specified by AUDITID described in the space corresponding to the column 71, SYSID being specified by the security management and audit program database 133; a software category 722 of the software program constructing the system, which is acquired from the system represented in the SYSID 721 by executing the audit program; a program name 723; update information 724 such as versions and patches; the apparatus category 725 in which the system operates; and the type information 726. Further, the column 73 describes security information for the system to be audited by the audit program, the security information including: the existence of the execution of the security measure which can be specified by the information security policy database 132, the security measure being represented by the information policy specified by POLICYID 61 which is made to correspond to the audit program in the security management and audit program database 133 shown in FIG. 6; and the security status 732 concerning the security measure of the system. The above security status 732 refers, for example, to setting information which relates to a connection of the router to an external network when the security measure is “a limitation of terminals able to access to an external network” and when the system to be audited is “router”. What information is to be acquired as the security status 732 is determined for each management program, depending on a system audited by the audit program, the information security policy and the like.

There will be described a support of the security management of the information system, which can be materialized by the use of this security policy management and audit support apparatus 31′.

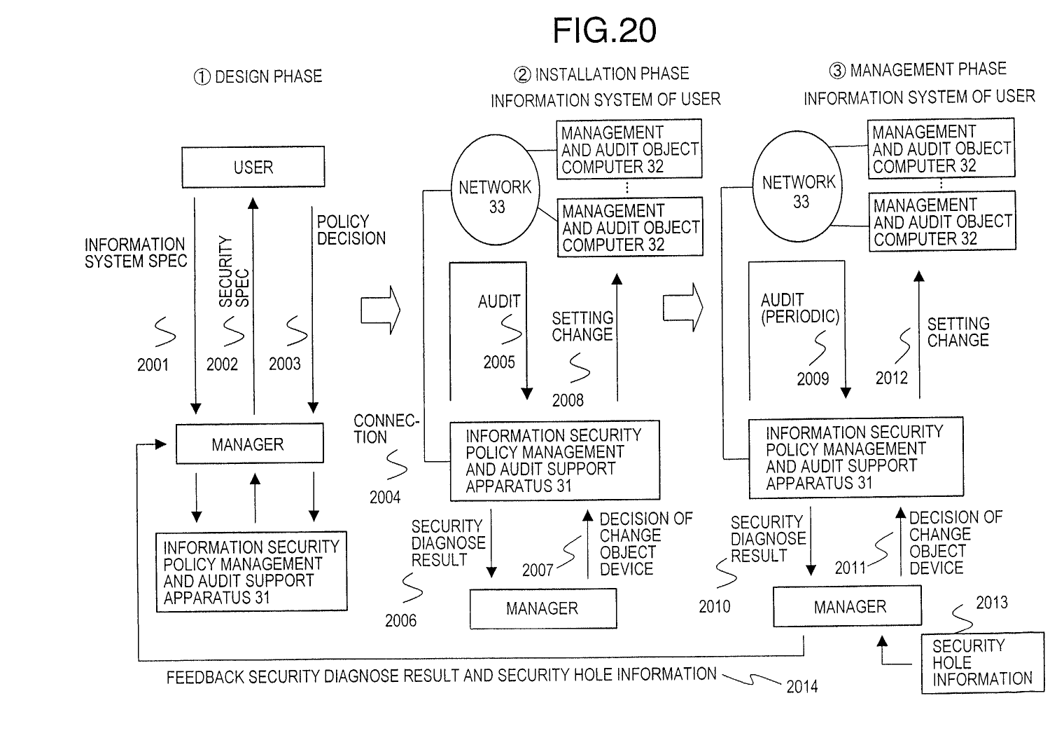

FIG. 20 schematically shows supporting procedures of the security management of the information system which can be materialized by the use of the security policy management and audit support apparatus 31′.

As shown in FIG. 20, the support procedures of the security management of the information system according to this embodiment are divided into three phases below.

(1) Design phase

By the use of the security policy management and audit support apparatus 31′, a manager receives specs of the information system constructed or to be constructed by a user (2001), and hatches security specs that can be applied to the information system. Then, the manager shows the security specs to the user (2002), and the user decides the information security policy applied to the information system. Then, the manager sets the information security policy management and audit support apparatus 31′ so that the security measure according to the decided information security policy can be audited and managed (2003).

(2) Installation phase

The security policy management and audit support apparatus 31′ is connected to the information system of the user (2004). Then, the security policy management and audit support apparatus 31′ diagnoses the security status of the information system concerning the information security policy decided in the design phase (2005, 2006), and changes the security status of the information system if necessary (2007, 2008).

(3) Management phase

The security policy management and audit support apparatus 31′ periodically diagnoses the security status concerning the information security policy of the user's information system, which has been decided in the design phase (2009, 2010). The security policy management and audit support apparatus 31′ specifies spots in which various information such as a software version and type, or the security status are changed after the installation phase (2011), and changes the security status of the spot if necessary (2012). Further, the security policy management and audit support apparatus 31′ checks the diagnose result of the security status with security hole information published by a security information organization such as CERT (Computer Emergency Response Team) (2013), and specifies the spot in which the security status has to be changed (2011). Then, the security policy management and audit support apparatus 31′ changes the security status (2012).

The manager preferably updates the information security policy management and audit support program 134 so that the security diagnosis result (2010) obtained from the information system of the user and the security hole information (2013) published by the security information organization are reflected in the constitution device information database 131, the information security policy database 132 and the security management and audit program database 133, whereby such contents can be reflected in the security policy system newly introduced into the information system of the user in the aftertime (2014).

There will be described an operation of the security policy management and audit apparatus 31′ in the design, installation and management phases shown in FIG. 20.

First, an operation in the design phase is described.

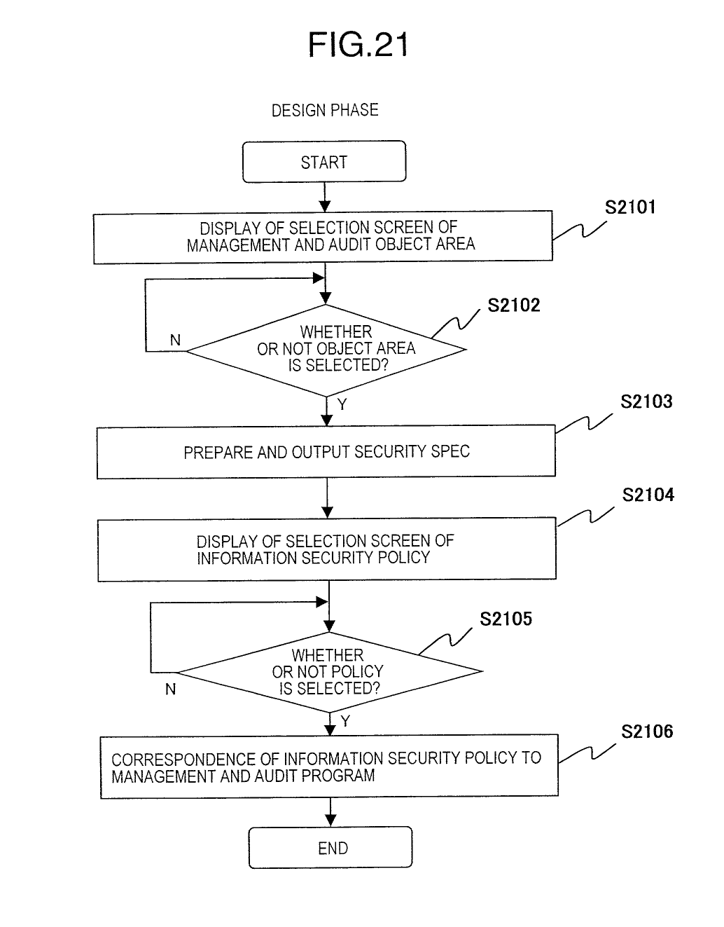

FIG. 21 shows operation procedures of the security policy management and audit apparatus 31′ in the design phase. Generally, these procedures are performed in a situation where the security policy management and audit apparatus 31′ is not connected to the information system of the user. At this stage, there is a possibility that the information system of the user is not yet constructed.

First, the management and audit object area control module 111 allows the display device 16 to display a selection screen of the information security policy management and audit object area as shown in FIG. 8, which illustrates the contents registered in the system constitution device information database 131 formed on the external storage device 13, by the use of the input/output control module 114 (step S2101). On this screen, the manager can designate and select a constitution device of the information system that has been constructed, or is to be constructed, by the user, which is indicated by the user. This selection result is reflected in the column 45 of the system constitution device information database 131 by the management and audit object area control module 111, and “YES” is registered as a selection possibility in the column 45 of the line describing the selected device specified by a combination of the apparatus category, the software category and the program name.

Then, when the manager selects the constitution device of the information system of the user (step S2102), the information security policy selection control module 112 retrieves AUDITID and PLICYID corresponding to SYSID in which “YES” is registered in the column 45 in the system constitution device information database 131 from the security management audit program database 133.

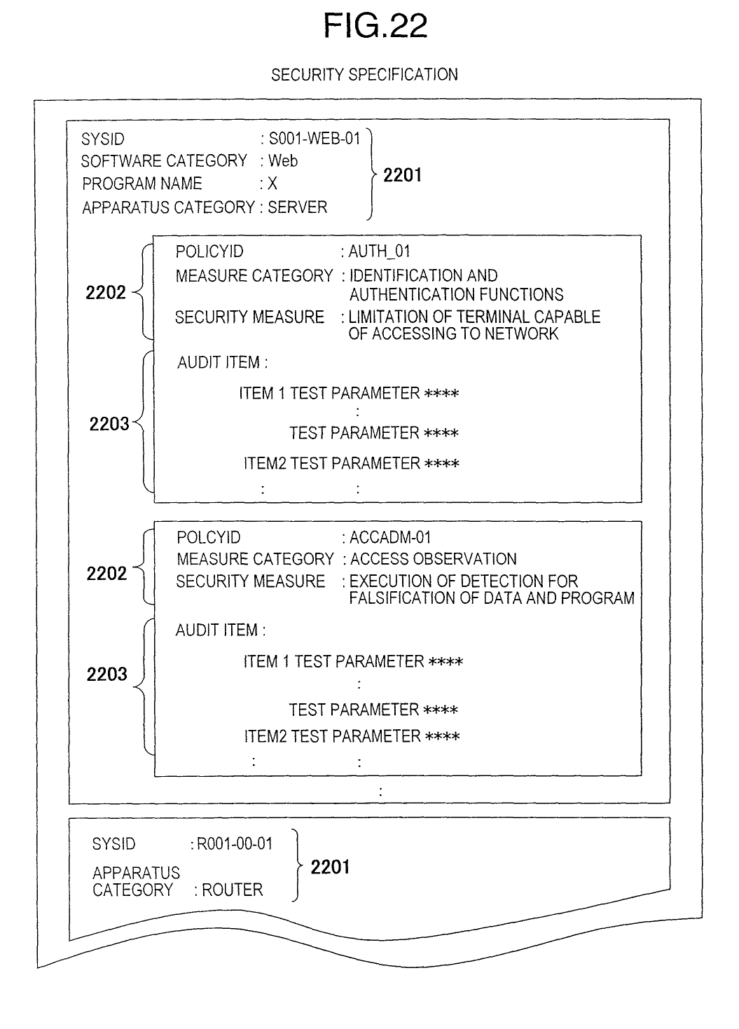

Then, for each constitution device specified by the information 2201 described in the line in which “YES” is registered in the column 45 in the system constitution device information database 131, the information security policy selection control module 112 prepares security specifications specifying the measure category and security measure (2202) of POLICYID corresponding to SYSID of the device and the audit (diagnose) items 2203 of the audit program of AUDITID corresponding to the foregoing SYSID and POLICYID as shown in FIG. 22. Note that the measure category and the security measure are specified by the information security policy database 132 and the audit (diagnose) items should be stored in the external storage device 13 or the like so as to correspond to the audit program. The prepared security specifications are displayed on the display device 16 by the use of the input/output control module 114, or outputted from a printing apparatus (not shown) (step S2103). The operator shows the security specifications to the user, so that the user can determine a security measure that should be applied to the information system that has been or is to be constructed by the user.

Then, the information security policy selection control module 112 allows the display device 16 to display the selection screen of the information security policy, as shown in FIG. 9, by the use of the input/output control module 114, the screen illustrating the measure category and security measure of POLICYID which is registered in the security management and audit program database 133 so as to correspond to SYSID described in the column 41 in which “YES” is registered in the column 45 in the system constitution device information database 131 (step S2104). Note that the security measure can be specified from the information security policy database 132. On this screen, the operator can designate and select the measure category and security measure, which are indicated by the user and are to be applied to the information system that has been constructed or is to be constructed by the user. The selection result is reflected in the column 54 of the information security policy database 132, and “YES” is registered as a possibility of the selection in the column 45 of the line describing the selected measure category and security measure.

Then, when the information security policy is selected by the manager (step S2105), the information security policy/security management and audit program correspondence control module 113 extracts management and audit programs corresponding to the selected information security policy and constitution device from the security management and audit program database 133, on the basis of the result selected in the steps S2101 to S2105. Then, “Necessity” is registered in the columns of correspondence 623 and 633 of the extracted management and audit programs (step S2106). Note that the extraction procedures are identical to those shown in FIG. 10.

By the above-described procedures, the audit program for auditing the execution status of each information security policy to be applied to the information system of the user and the management program for changing the status thereof has been set into the security policy management and audit apparatus 31′.

An operation of the installation phase will be described below.

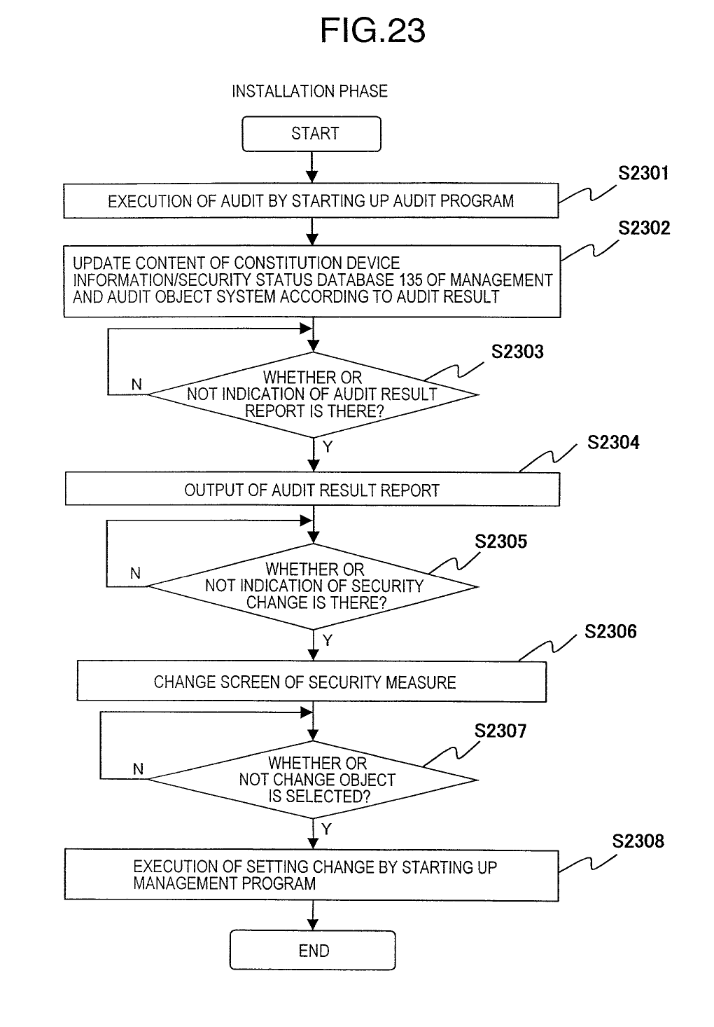

FIG. 23 shows operation procedures of the security policy management and audit apparatus 31′ in the installation phase. These procedures are performed when the security policy management and audit apparatus 31′ through the design phase is connected to the information system constructed by the user.

First, the information security policy/security management and audit program correspondence control module 113 starts up a management program in which “Necessity” is marked in the correspondence column 633 of the security management and audit program database 133 among the management and audit program group 136 on the management and audit object computer 32 through the network 33, to construct the security audit module 140 on the management and audit object computer 32 (step S2301).

The security audit module 140 audits various information of the constitution device and the security status of the audit object system. Note that the various information includes version information of a software program constructing the audit object system and information such as a type of the apparatus in which the audit object system operates, and that the security status means existence of the execution of the security measure represented by the information security policy corresponding to the audit program and a security status of the audit object system related to the security measure. Then, the security audit module 140 sends the audit result to the information security policy/security management and audit program correspondence control module 113 through the network 33. The information security policy/security management and audit program correspondence control module 113 updates the contents of the constitution device information/security status database 135 of the management and audit object system depending on the responded audit result (step S2302).

Then, when the information security policy/security management and audit program correspondence control module 113 receives the audit result report indication from the manager through the input/output control module 114 (step S2303), the information security policy/security management and audit program correspondence control module 113 allows the display device 16 to display the contents of the constitution device information/security status database 135 of the management and audit object system as the latest audit result report by the use of the input/output control module 114, or outputs the contents thereof from a printing apparatus (not shown) (step S2304).

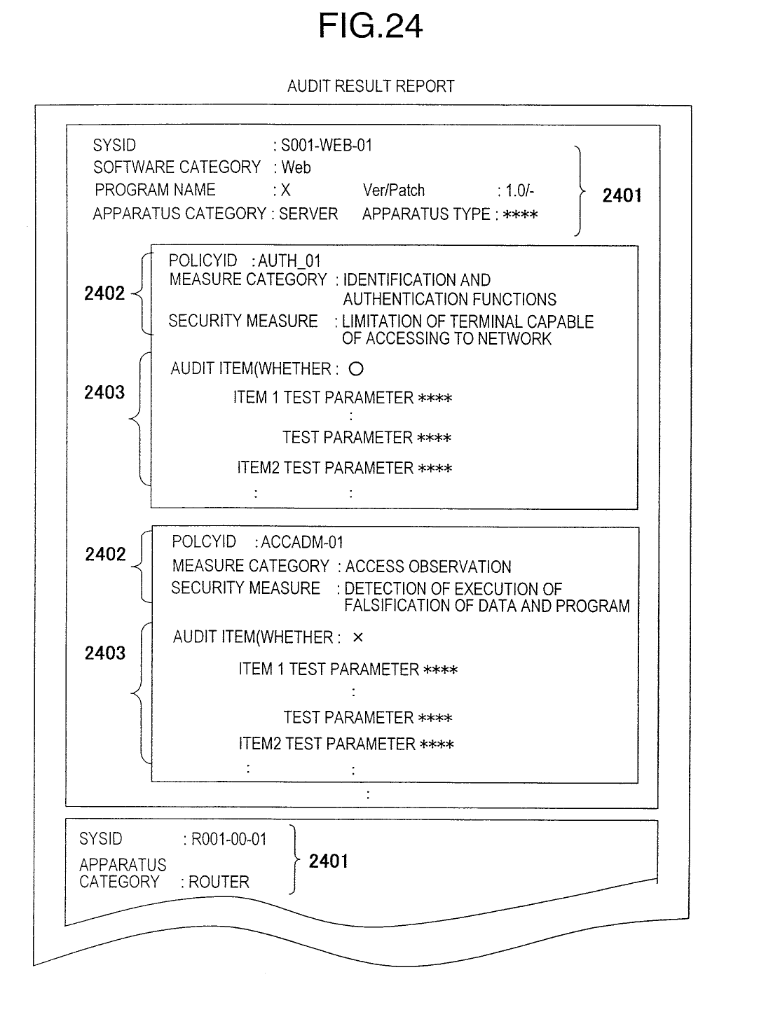

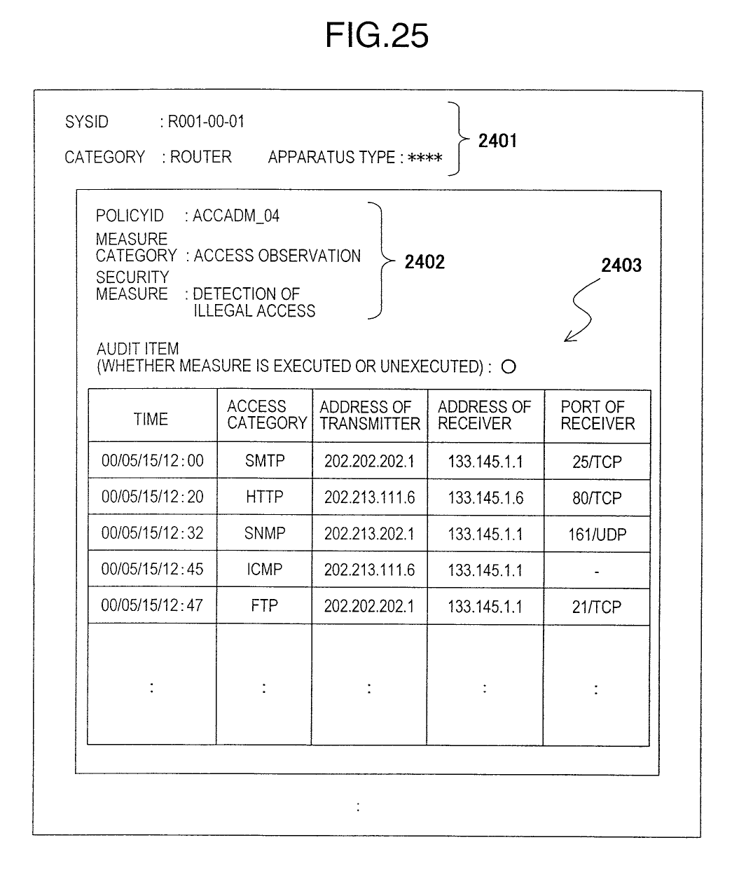

FIG. 24 shows an example of the audit result report. As shown in FIG. 24, the measure category and the security measure 2402 indicated by the information policy of POLICYID, which is made to correspond to the SYSID of the device, as well as the audit (diagnose) result 2403 for the audit item of the audit program of the AUDITID described in the column 71, which is made to correspond to SYSID of the device, are described for each constitution device 240 specified by the latest various information of the system described in the column 72 of the constitution device information/security status database 135 of the management and audit object system. The measure category and the security measure 2402 can be specified by the information security policy database 132. Note that the audit result 2403 is prepared on the basis of the security information described in the column 73 of the constitution device information/security status database 135 of the management and audit object system. As described above, the security information is decided depending upon the information security policy, the system audited by the audit program and the like. For example, when the system specified by SYSID which is made to correspond to the audit program is a router, and when the measure category and the security measure indicated by the information security policy of POLICYID, which is made to correspond to the audit program, are an access espial and a detection of illegal access, respectively, a record of the illegal access detected by the security management module 139 constructed on the management and audit object computer 32 by starting up the management program, which is made to correspond to the same SYSID and POLICYID, constitutes the security information. In this case, the record of the illegal access is displayed as the audit result 2403, as shown in FIG. 25.

On the basis of the audit result report, the manager can confirm the execution status of the security measure indicated by each information security policy determined to be applied to the information system of the user in the design phase, and the manager can specify a system constitution device whose security status is required to change.

Then, when the information security policy/security management and audit program correspondence control module 113 receives an instruction to change the security status from the manager through the input/output control module 114 (step S2305), the manager selects a desired management program among the management programs in which “Necessity” is marked in the correspondence column 633 of the security management and audit program database 133 (step S2306) and allows the display device 16 to display a screen to designate the change of the security measure by the use of the input/output control module 114. This screen preferably shows a list of the measure category and the security measure indicated by the information security policy database of POLICYID 61 corresponding to each management program in which “Necessity” is marked in the correspondence column 633 of the security management and audit program database 133. The measure category and the security measure can be specified on the basis of the information security policy database 132. With such a display, the manager can select a measure category and a security measure desired to be changed and can select a management program for changing the security measure without knowledge concerning the management program.

When the management program is selected by the manager (step S2307), the information security policy/security management and audit program correspondence control module 113 starts up the selected management program among the management and audit program group 136 on the management and audit object computer 32 through the network 33, to construct the security management module 139 on the management and audit object computer 32 (step S2308).

The security management module 139 executes processings in accordance with the security measure indicated by the information security policy made to correspond the management program that has constructed itself on the management and audit object computer 32. For example, the security management module 139 allows the display device 16 of the security policy management and audit apparatus 31′ to display the management screen such as a setting change of the security status as shown in FIG. 12, and promotes the manager to enter the contents of the setting change of the security status. Then, the security management module 139 obtains the contents of the setting change of the security status, which is received from the manager, from the security policy management and audit apparatus 31′ through the network 33, and changes the security status in accordance with the received contents.

The above-described procedures ensure that the security measure of each information security policy determined in the design phase is executed in the information system constructed by the user.

An operation in the management phase will be described below.

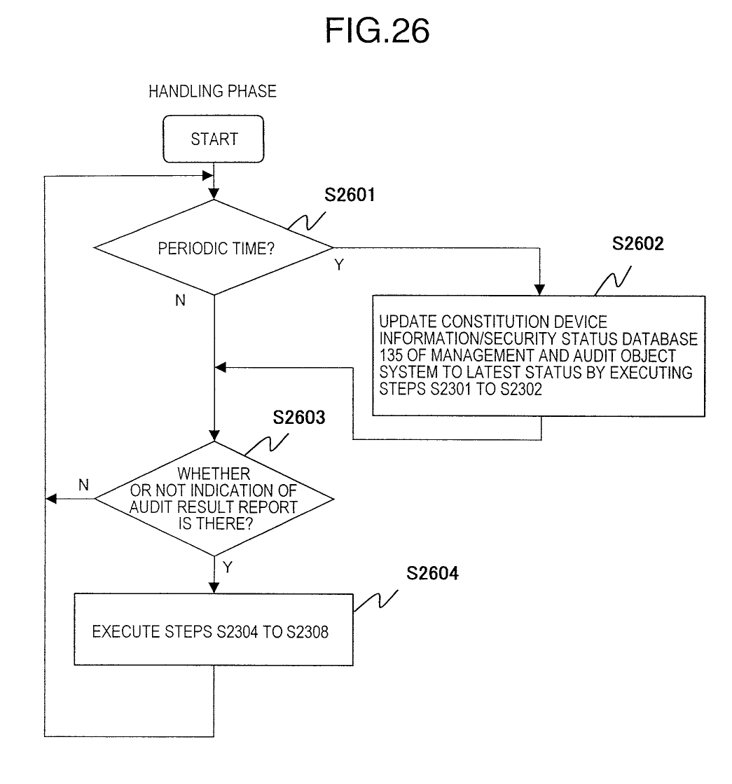

FIG. 26 shows operation procedures of the security policy management and audit apparatus 31′ in the management phase. The procedures are executed for the information system in which the execution of the security measure of each information security policy determined in the design phase has been confirmed by the processings in the management phase.

First, the information security policy/security management and audit program correspondence control module 113 periodically executes the steps S2301 and S2302 shown in FIG. 23 (step S2601 and S2602), and updates the contents of the constitution device information/security status database 135 of the management and audit object system to the newest state. Further, when the information security policy/security management and audit program correspondence control module 113 receives the audit result report indication from the manager through the input/output control module 114 (step S2603), the information security policy/security management and audit program correspondence control module 113 executes the steps S2304 to S2308 shown in FIG. 23 (step S2604).

With such processings, in accordance with the audit result report made on the basis of the contents of the constitution device information/security status database 135 of the management and audit object system updated in the latest state, the manager can specify the system in which the version up of the software, the application of the patch, or the change of the type of the apparatus is executed and the system in which the security status is changed, after the installation phase. Then, the manager can change the security status of the system as required.

Further, the manager checks the foregoing audit result report with the security hole information published by the security information organization such as CERT, and can specify a system for which it is caused to be necessary to change the security status such as software for constructing a system in which a security hole is found. Then, the security status of the system can be changed as the occasion demands.

Further, the manager specifies a system in which nothing is changed after the installation phase, on the basis of the foregoing audit result report, and when a version up and a patch are published for the software for constructing the system, the manager urges the application thereof. When an apparatus of a new type is put into a practical use as a manufactured product in the apparatus in which the system operates, the manager can also urge a change from the apparatus to this apparatus of the new type.

The second embodiment of the present invention has been described hereinabove.

In this embodiment, the second embodiment has been explained on the assumption that one security policy management and audit apparatus 31′ is used in the design, installation and management phases. However, the apparatus which executes the processings from the step S2101 to the step 2106 of FIG. 21 and which prepares the security specifications and outputs it in the design phase may be another apparatus provided separately from the security policy management and audit apparatus 31′.

Specifically, there may be employed the following constitution. In FIG. 18, by the use of the electronic computer loading the information security policy management and audit support program 134 capable of constructing at least the management and audit object area control module 111, the information security policy selection control module 112 and the input/output control module 114 and capable of forming the system constitution device information database 131, the information security policy 132 and the security management and audit program database 135 in the external storage device 13 or the like, the manager prepares the security specifications in accordance with the spec of the information system instructed by the user, and shows the security specifications to the user. Then, the manager enters the information security policy decided by the user and to be applied to the information system, into the security policy management and audit apparatus 31′, whereby the manager sets the audit program for auditing the execution status of the information security policy and the management program for changing the status thereof into the security policy management and audit apparatus 31′.

According to this embodiment, in addition to the effects of the foregoing first embodiment, it is possible to support the manager so that he/she can execute the series of procedures including the preparation of the information security policy, the introduction of the security system to the information system in accordance with the information security policy and the handling and management thereof without a highly specialized knowledge concerning the information security policy and the security system.

Note that the present invention shall not be limited to the foregoing embodiments, and various modifications are possible within the scope of the present invention.

For example, though the management and audit programs are arranged on the management and audit object computer 32 in the foregoing embodiments, there may be employed a constitution in which the management and audit programs are constituted as a so-called management and agent type program for auditing and managing the system on the management and audit object computer 32 through the network 33, and the management and audit programs are arranged on the information security policy management and audit support apparatuses 31 and 31′.

Further, in the foregoing embodiments, the management and audit programs themselves may execute other processings concerning the information security policy such as virus check, a change of a password and a collection of logs. Alternatively, the management program and the audit program may manage and audit the execution of the program for performing these processings.

As described above, according to the present invention, it is possible to easily control and manage the status of the security of the information system in accordance with the information security policy. Further, it is possible to support the manager so that he/she can execute the series of procedures including the preparation of the information security policy, the introduction of the security system to the information system in accordance with the information security policy and the handling and management thereof without a highly specialized knowledge concerning the information security policy and the security system.

What is claimed is:

1. A security management system for controlling a security status of each of a plurality of managed systems constituting an information system in accordance with an information security policy representing a policy of a security measure, comprising:
a plurality of management sections corresponding to at least one managed system and the information security policy, each management section being for controlling the security status of the managed system corresponding thereto so as to adjust the security status to the information security policy corresponding thereto;
a database registering a correspondence of the information security policy, the managed system and each management section;
a security content reception section for receiving a selection of a range of the information security policy and the managed system from a user;
an extraction section for extracting from said database the management section registered so as to correspond to the information security policy and the managed system included in the range in which said security content reception section has received the selection; and
a management control section for allowing the management section extracted by said extraction section to change the security status of the managed system corresponding to the management section so as to adjust to the information security policy corresponding to the management section.

2. A security management system for auditing a security status of each of a plurality of managed systems constituting an information system, the security status concerning an information security policy representing a policy of a security measure, comprising:
a plurality of audit sections corresponding to at least one managed system and at least one information security policy, each audit section being for auditing the security status concerning the corresponding information security policy of the corresponding managed system;
a database registering a correspondence of the information security policy, the managed system and the audit section;
a security content reception section for receiving a selection of a range of the information security policy and the managed system from the user;
an extraction section for extracting from said database the audit section registered so as to correspond to the information security policy and the managed system included in the range in which said security content reception section has received the selection; and
an audit control section for allowing the audit section extracted by said extraction section to audit the security status concerning the information security policy of the managed system corresponding to the audit section.

3. A security management system for controlling a security status of each of a plurality of managed systems constituting an information system in accordance with an information security policy representing a policy of a security measure, comprising:
a plurality of management sections corresponding to at least one managed system and at least one information security policy, each management section being for controlling the security status of the corresponding managed system so as to adjust the security state to the corresponding information security policy;
a plurality of audit sections corresponding to at least one managed system and at least one information security policy, each audit section being for auditing the security status concerning the corresponding information security policy of the corresponding managed system;
a database registering a correspondence of the information security policy, the managed system, the management section and the audit section;
a security content reception section for receiving a selection of a range of the information security policy and the managed system from a user;
an extraction section for extracting from said database the management section and the audit section, which are registered so as to correspond to the information security policy and the managed system included in the range in which said security content reception section has received the selection;
a management control section for allowing the management section extracted by said extraction section to change the security status of the managed system corresponding to the management section so as to adjust to the information security policy corresponding to the management section; and
an audit control section for allowing the audit section extracted by said extraction section to audit the security status concerning the information security policy of the managed system corresponding to said audit section.

4. A security management method for controlling a security status of each of a plurality of managed systems constituting an information system with an electronic computer in accordance with an information security policy representing a policy of a security measure, comprising the steps of:
receiving a selection of a range of the information security policy and the managed system from a user;
extracting a management program corresponding to an information security policy and a managed system, included in the range in which the selection has been received, among a plurality of management programs describing a processing for controlling the security status of the corresponding managed system so as to adjust the security status to the corresponding information security policy, the plurality of management programs corresponding to at least one information security policy and at least one managed system, which are previously stored; and
allowing the electronic computer to execute the extracted management program and to change the security status of the managed system corresponding to the management program so that the security status thereof is adjusted to the information security policy corresponding to the management program.

5. A security management method for auditing, with an electronic computer, a security status of each of a plurality of managed systems constituting an information system, the security status concerning an information security policy representing a policy of a security measure, comprising the steps of:
receiving a range of a selection of the information security policy and the managed system from a user;
extracting an audit program registered so as to correspond to the information security policy and the managed system, which are included in the range in which the selection has been received, among a plurality of audit programs describing a processing for auditing the security status concerning the corresponding information security policy of the corresponding managed system, the plurality of audit programs corresponding to at least one information security policy and at least one managed system, which are previously stored; and
allowing the electronic computer to execute the extracted audit program and to audit the security status of the managed system corresponding to the audit program, the security status concerning the information security policy corresponding to the audit program.

6. A storage medium storing a program for controlling a security status of each of a plurality of managed systems constituting an information system in accordance with an information security policy representing a policy of a security measure,
wherein said program is read out and executed by an electronic computer,
to construct, on said electronic computer,
a security content reception section for receiving a selection of a range of the information security policy and the managed system from a user;
an extraction section for extracting a management program corresponding to an information security policy and a managed system, which are included in the range in which said security content reception section has received the selection, from a database storing a plurality of management programs describing a processing for controlling the security status of the corresponding managed system so as to adjust the security status of the managed system to the corresponding information security policy, the plurality of management programs corresponding at least one managed system and at least one information security policy; and
a management control section for allowing said electronic computer to execute the management program executed by said extraction section and to change the security status of the managed system corresponding to the extracted management program so as to adjust the security status to the information security policy corresponding to the extracted management program.

7. A storage medium storing a program for auditing a security status concerning an information security policy representing a policy of a security measure of a plurality of managed systems constituting an information system,
wherein said program is read out and executed by an electronic computer,
to construct, on said electronic computer,
a security content reception section for receiving a selection of a range of the information security policy and the managed system from a user;
an extraction section for extracting an audit program registered so as to correspond to an information security policy and a managed system, which are included in the range in which said security content reception section has received the selection, from a database storing a plurality of audit programs describing a processing for auditing the security status concerning the corresponding information security policy of the corresponding managed system, the plurality of audit programs corresponding to at least one managed system and at least one information security policy; and
an audit control section for allowing the electronic computer to execute the audit program extracted by said extraction section and to audit the security status concerning the information security policy corresponding to the audit program of the managed system corresponding to the audit program.

8. A security management method for supporting a security management of each of a plurality of managed systems constituting an information system with an electronic computer, comprising:
a security specification hatching step of extracting an information security policy made to correspond to each managed system constituting an information system designated by a user from a database describing a correspondence of an information security policy representing a policy of a security measure with at least one managed system, to hatch security specifications to be applied to the information system;
a security diagnosis step of executing a plurality of audit programs describing a processing for auditing various information including a type of the managed system and a software version, which are stored so as to correspond to each set of the information security policy and the managed system, the information security policy and the managed system being specified by security specifications hatched in said security specification hatching step, as well as a security status concerning the information security policy of the managed system, to audit the various information including the type and the software version of the managed system constituting the information system designated by the user, and to diagnose a security of said information system; and
a security handling and management step of executing a management program designated by the user, among a plurality of management programs describing a processing for controlling the security status concerning the information security policy of the managed system stored so as to correspond to each set of the information security policy and the managed system, which are specified by the security specifications hatched in said security specification hatching steps, to allow said electronic computer to change the security status of the managed system corresponding to the management program so as to adjust the security status to the information security policy corresponding to the management program.

9. The security management method according to claim 8,
wherein, in said security diagnosis step, the audit program made to correspond to each set of the information security policy and the managed system, which are specified by the security specifications hatched in said security specification hatching step, is extracted from a database describing a correspondence of the information security policy, the managed system and the audit program describing a processing for auditing various information such as a type and a software version of said managed system as well as the security status concerning said information security policy of said managed system, and executed, to diagnose the security of the information system designated by said user; and
in said security handling and management step, the management programs made to correspond to each set of the information security policy and the managed system, which are specified by the security specifications hatched in said security specification hatching step, are extracted from a database describing a correspondence of the information security policy, the managed system and the management program describing a processing for controlling the security status concerning the security policy, the managed system and said information security policy of a security of said managed system, and the management program designated by the user is extracted among the extracted programs to be executed, to allow the security status of the managed system corresponding to the extracted management program to adjust to the information security policy corresponding to the management program.

10. The security management method according to claim 8,
wherein said security diagnose step is executed periodically.

11. The security management method according to claim 8,
wherein, in accordance with a setting content received from the user, said management program changes the security status of the managed system corresponding to the management program so as to adjust the security status to the information security policy corresponding to the management program.

12. The security management method according to claim 8,
wherein a security hole information published by a security information organization including CERT or Computer Emergency Response Team and diagnosis results obtained in said security diagnose step which is executed for the information system designated by the user are reflected in the database describing the correspondence of the information security policy with at least one managed system and an audit/management program stored so as to correspond to each set of the information security policy and the managed system.

13. A security management system for supporting a security management of managed systems constituting an information system, comprising:
a database describing a correspondence of an information security policy representing a policy of a security measure with at least one managed system;
a security specification hatching section for extracting an information security policy made to correspond to each of the managed systems constituting the information system designated by a user from said database, to hatch security specifications to be applied to the information system;
a plurality of audit sections for auditing various information including a type and a software version of the managed system as well as a security status concerning the information security policy of the managed system, each audit section being provided so as to correspond to each set of the information security policy and the managed system, which are specified by security specifications hatched by said security specification hatching section, and;
a security diagnosis section for diagnosing a security of an information system designated by said user, on the basis of diagnosis results in each of said audit sections;
a plurality of management sections for controlling a security status concerning the information security policy of the managed system, each management section being provided so as to correspond to each set of the information security policy and the managed system, which are specified by security specifications hatched by said security specification hatching step, and;
a security handling and management section for executing a management section designated by said user, to change the security status of the managed system corresponding to the management program so as to adjust the security status to the information security policy corresponding to the management program.
